(19) United States
(12) Patent Application Publication
(10) Pub. No.: US 2022/0227201 A1
(43) Pub. Date: Jul. 21, 2022

(54) AIR CONDITIONER FOR VEHICLE

(71) Applicant: MITSUBISHI HEAVY INDUSTRIES THERMAL SYSTEMS, LTD., Tokyo (JP)

(72) Inventor: Noriyuki CHIKAGAWA, Tokyo (JP)

(73) Assignee: MITSUBISHI HEAVY INDUSTRIES THERMAL SYSTEMS, LTD., Tokyo (JP)

(21) Appl. No.: 17/616,510

(22) PCT Filed: Jun. 16, 2020
(86) PCT No.: PCT/JP2020/023516

§ 371 Date: Dec. 3, 2021

(30) Foreign Application Priority Data
Jun. 21, 2019 (JP) 2019-115307

(51) Int. Cl. B60H 1/00

(52) U.S. Cl. CPC B60H 1/00521; B60H 2001/00707; B60H 1/00678

(57) ABSTRACT

The present invention comprises: a unit case; a damper which switches between the open state and the closed state of a flow path; a plurality of damper levers which have pins and rotatably support the damper with respect to the unit case; and a main lever which has guide grooves into which the pins are fitted, and rotates the damper levers by guiding pins through rotation around an axis, wherein the main lever has a main lever body having the guide groove formed therein, and a shaft part which rotatably supports the main lever body and is provided with a hook portion engaged with the unit case, and the shaft part has a higher toughness than the main lever body and is made of a material different from that of the unit case.

### TECHNICAL FIELD

The present invention relates to an air conditioner for a vehicle.

Priority is claimed on Japanese Patent Application No. 2019-115307 filed on Jun. 21, 2019, the content of which is incorporated herein by reference.

### BACKGROUND ART

For example, as described in PTL 1 below, an air conditioner for a vehicle used in an automobile or the like includes a heater core that is a heat exchanger for heating, an evaporator that is a heat exchanger for cooling, a unit case that defines an air mixing space in which warm air or cold air passing through the heater core and the evaporator is mixed, and an air mixing damper that changes the mixing ratio between the warm air and the cold air in the air mixing space. In the case of such a device, it is possible to achieve air having a desired temperature with a change in mixing ratio between the cold air and the warm air by adjusting the amount of rotation of the air mixing damper.

The air mixing damper is rotatably supported with respect to the unit case via a member called a damper lever. The damper lever is integrally provided with a pin that protrudes in a direction orthogonal to a direction in which the damper lever rotates. The pin is fitted into a guiding groove of a main lever provided separately from the damper lever. The main lever rotates around the axis thereof by being driven by a driving source (actuator). When the main lever rotates, the pin of the damper lever is guided along the guiding groove, and thus the posture (angle of rotation) of the damper lever is changed.

The main lever has a sliding portion that slides with respect to the unit case and the damper lever. In the above-described example, the main lever rotates in a state of being inserted into a hole portion formed in the unit case. In addition, the guiding groove formed on the main lever is in a state of being in slide-contact with the pin of the damper lever. Therefore, it is necessary to reduce friction generated between the main lever, the damper lever, and the unit case. Here, in the related art, each of the main lever and the damper lever is generally formed of polyacetal (POM) or polybutylene terephthalate (PBT).

### CITATION LIST

### Patent Literature

[PTL 1] Japanese Unexamined Patent Application Publication No. 2017-13733

### SUMMARY OF INVENTION

### Technical Problem

However, since the main lever and the damper lever slide on each other as described above, in a case where the main lever and the damper lever are formed of the same member, a frictional force generated between the main lever and the damper lever becomes large. As a result, sliding portions between the main lever and the damper lever may be worn or deteriorated at an early stage. As a result, the durability of the air conditioner for a vehicle is limited.

The present invention has been made to solve the above-described problems, and an object thereof is to provide an air conditioner for a vehicle that is inexpensive and that has a high durability.

### Solution to Problem

According to an aspect of the present invention, there is provided an air conditioner for a vehicle which is installed in the vehicle, the air conditioner including an evaporator that cools air, a heater core that heats the air, a unit case that accommodates the evaporator and the heater core and in which an air mixing space where the air supplied from the evaporator and the air supplied from the heater core are mixed with each other is defined and a plurality of flow paths through which the air mixed in the air mixing space flows are formed, a plurality of dampers that cause the plurality of flow paths to switch between an open state and a closed state, a plurality of damper levers that rotatably support the plurality of dampers with respect to the unit case and that include pins extending to be parallel to rotation axes of the dampers, and a main lever in which a guiding groove into which the pins are fitted is formed and that rotates around an axis to guide the pins and to rotate the damper levers. The main lever includes a main lever main body in which the guiding groove is formed and a shaft portion that is provided at a position of the axis, supports the main lever main body with respect to the unit case such that the main lever main body is rotatable around the axis, and is provided with a claw portion that is engaged with the unit case so as not to fall off from the unit case, and the shaft portion has a toughness higher than the main lever main body and is formed of a material different from the unit case.

According to the above-described configuration, the main lever includes the main lever main body and the shaft portion. Of these, the shaft portion has a toughness higher than the main lever main body and is formed of a material different from the unit case. Therefore, in comparison with a configuration in which the shaft portion and the unit case are formed of the same material, a frictional force generated between the shaft portion and the unit case can be reduced. Furthermore, since the main lever main body and the shaft portion are formed of different materials from each other, the damper levers sliding on the main lever main body can be formed of the same material as the shaft portion. In this case as well, a frictional force generated between the damper levers and the main lever main body can be reduced. Furthermore, since it is easy to select an inexpensive material, cost reduction can be realized.

In the air conditioner for a vehicle, the shaft portion and the damper levers may be formed of one material selected from the group consisting of polyacetal and polybutylene terephthalate, and the main lever main body may be formed of polypropylene.

According to the above-described configuration, the toughness of the shaft portion and the damper levers can be made higher than the toughness of the main lever main body.

In the air conditioner for a vehicle, an extension portion that extends in a radial direction with respect to the axis may be formed at an end portion of the shaft portion that is on a side opposite to the claw portion.

According to the above-described configuration, the shaft portion is engaged with the unit case from one side via the claw portion and is fixed to the unit case from the other side by means of the extension portion provided on the end portion that is on the side opposite to the claw portion. That is, since the extension portion is provided, it is possible to eliminate a possibility that the shaft portion falls off toward the other side from the one side.

In the air conditioner for a vehicle, at least one of the plurality of dampers may be an air mixing damper that is provided in the air mixing space and that adjusts a mixing state of the air supplied from the evaporator and the air supplied from the heater core.

Here, the air mixing damper generally rotates more frequently than the other dampers at the time of adjustment of the temperature of air to be sent. That is, it is particularly important to reduce a frictional force caused by a sliding motion between the air mixing damper and the unit case. According to the above-described configuration, a frictional force generated between the air mixing damper and the unit case can be reduced, and it is possible to more stably operate the air conditioner for a vehicle.

### Advantageous Effects of Invention

According to the present invention, it is possible to provide an air conditioner for a vehicle that is inexpensive and that has a high durability.

### BRIEF DESCRIPTION OF DRAWINGS

FIG. 1 is a cross-sectional view showing the configuration of an air conditioner for a vehicle according to an embodiment of the present invention.

FIG. 2 is a vertical cross-sectional view showing the vicinity of dampers in the air conditioner for a vehicle shown in FIG. 1.

FIG. 3 is an enlarged cross-sectional view of a main part of FIG. 2.

### DESCRIPTION OF EMBODIMENTS

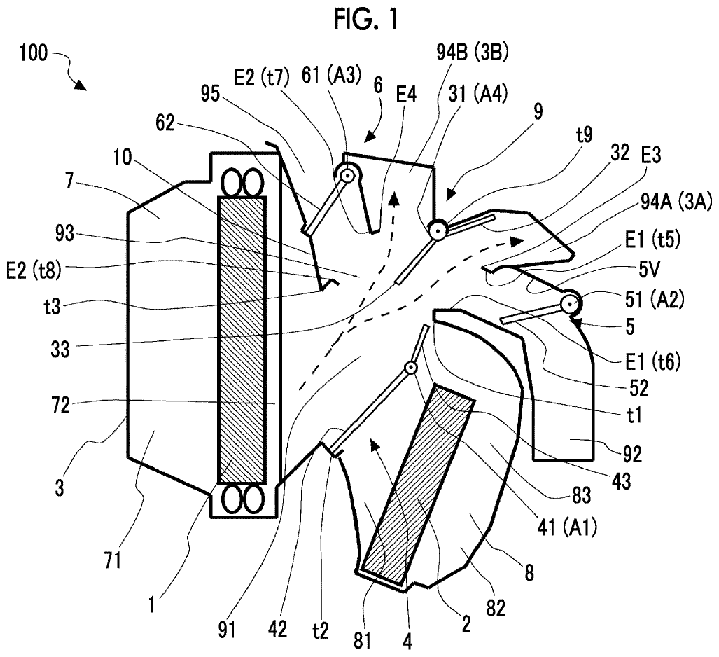

An embodiment of the present invention will be described with reference to the drawings. As shown in FIG. 1, an air conditioner 100 for a vehicle according to the present embodiment includes an evaporator 1, a heater core 2, a unit case 3 that accommodates the evaporator 1 and the heater core 2, a plurality of dampers D (air mixing damper 4, foot switching damper 5, defroster switching damper 6, and face damper 9) for adjusting the flow of air inside the unit case 3, a main lever 20 that supports the dampers D with respect to the unit case 3, and damper levers 24. Note that FIG. 1 is a cross-sectional view of the air conditioner 100 for a vehicle as seen in a width direction, which is a direction intersecting a traveling direction of a vehicle into which the air conditioner 100 for a vehicle is installed.

As the evaporator 1, for example, a heat exchanger for cooling for which a vapor compression refrigerating cycle is adopted is used. A low-pressure refrigerant flowing in the evaporator 1 is evaporated through absorption of heat from air flowing around the evaporator 1 so that the air is cooled. In the present embodiment, the evaporator 1 is formed in a thick plate-like shape.

As the heater core 2, a warm water type heat exchanger for heating that heats air with warm water (that is, engine cooling water) from an engine or the like for a vehicle (not shown) is used. An amount of heat from warm water flowing inside the heater core 2 is applied to air flowing around the heater core 2 so that the air is heated. In the present embodiment, the heater core 2 is also formed in a thick plate-like shape as with the evaporator 1.

The unit case 3 accommodates the evaporator 1 and the heater core 2, and an air flow path is defined inside the unit case 3. More specifically, inside the unit case 3, a cooling space 7, a heating space 8, a foot discharge flow path 92, an air mixing space 91, a relay space 93, a center discharge flow path 94A, a side discharge flow path 94B, and a defroster discharge flow path 95 (defroster discharge flow path) are formed.

The evaporator 1 is accommodated in the cooling space 7. The evaporator 1 divides the cooling space 7 into two spaces. More specifically, the cooling space 7 includes an introduction space 71 and a cold air supply space 72. A space formed on one side of the evaporator 1 in the traveling direction of the vehicle is the introduction space 71 through which air introduced by a fan or the like (not shown) flows. The space on the other side of the evaporator 1 (that is, the space formed on the side opposite to the introduction space 71 with respect to the evaporator 1) is the cold air supply space 72 through which air cooled by the evaporator 1 flows. That is, air in the introduction space 71 is cooled when the air comes into contact with the evaporator 1 by being sent by the fan and flows into the cold air supply space 72 thereafter.

The heater core 2 is accommodated in the heating space 8. The heating space 8 communicates with the cooling space 7 via a portion of the air mixing space 91, which will be described later. More specifically, the heating space 8 is provided at a position facing the cooling space 7 from the cold air supply space 72 side. The heater core 2 divides the heating space 8 into three spaces. The heating space 8 includes a second introduction space 81, a warm air supply space 82, and a return space 83. A space on one side (that is, the side facing the cooling space 7 from the heater core 2) with respect to the heater core 2 in the traveling direction of the vehicle is the second introduction space 81 into which air supplied from the cold air supply space 72 is introduced. A space on the other side with respect to the heater core 2 (the space formed on the side opposite to the second introduction space 81 with respect to the heater core 2) is the warm air supply space 82 through which air heated by the heater core 2 flows. That is, air inside the second introduction space 81 is heated when the air comes into contact with the heater core 2 and flows into the warm air supply space 82 thereafter.

Furthermore, in the heating space 8, a space is formed between an upper end portion of the heater core 2 and an inner wall of the unit case 3. The space is the return space 83 through which air passing through the second introduction space 81 and the warm air supply space 82 in this order returns to the air mixing space 91, which will be described later.

The cooling space 7 and the heating space 8 configured as described above communicate with each other via the air mixing space 91. In the air mixing space 91, air cooled in the cooling space 7 (cold air) and air heated in the heating space 8 (warm air) are mixed with each other. More specifically, the air mixing space 91 is a flow path that communicates with the cold air supply space 72 of the cooling space 7 and the warm air supply space 82 of the heating space 8 and extends upward. On the cooling space 7 side in the air mixing space 91, a guide partition wall portion 10 that guides air flowing through the air mixing space 91 to an upper side is provided.

The air mixing space 91 is provided with the air mixing damper 4 that adjusts the mixing ratio (mixing state) between air introduced from the cooling space 7 and air introduced from the heating space 8. The air mixing damper 4 is a plate-shaped member rotatably supported by the unit case 3 at a boundary between the air mixing space 91 and the heating space 8. More specifically, the air mixing damper 4 includes a rotary shaft 41 that rotates around a central axis A1 extending in a vehicle width direction, an air mixing damper main body 42, and a reheating prevention damper 43, the air mixing damper main body 42 and the reheating prevention damper 43 extending on a plane intersecting the width direction with the rotary shaft 41 interposed therebetween.

In the present embodiment, the rotary shaft 41 is provided on a straight line connecting an upper end portion (first end portion t1) and a lower end portion (second end portion t2) of the boundary between the air mixing space 91 and the heating space 8. Furthermore, the rotary shaft 41 is provided at a position that coincides with an upper end portion of the heater core 2 in a vertical direction as seen in a cross-sectional view. In addition, a dimension from the rotary shaft 41 to a lower end portion (third end portion t3) of the guide partition wall portion 10 is approximately the same as a dimension from the rotary shaft 41 to the second end portion t2.

The air mixing damper main body 42 extends by the dimension from the rotary shaft 41 to the second end portion t2 (similarly, by the dimension from the rotary shaft 41 to the third end portion t3 of the guide partition wall portion 10) as seen in the cross-sectional view. On the other hand, the reheating prevention damper 43 extends in a direction opposite to a direction in which the air mixing damper main body 42 extends with the rotary shaft 41 interposed therebetween. More specifically, the reheating prevention damper 43 extends to be inclined toward the air mixing space 91 side with respect to a plane along which the air mixing damper main body 42 extends.

The air mixing damper 4 configured as described above is rotatable between a maximum cooling position shown in FIG. 1 and a maximum heating position (not shown). At the maximum cooling position, a tip portion of the air mixing damper main body 42 (an end portion on the side opposite to the rotary shaft 41) comes into contact with the second end portion t2 from the air mixing space 91 side. At the same time, the reheating prevention damper 43 is held at a position facing the first end portion t1 from the rotary shaft 41 in the vertical direction. Accordingly, at the maximum cooling position, the cooling space 7 and the heating space 8 are divided by the air mixing damper main body 42, and the cooling space 7 and the air mixing space 91 communicate with each other.

On the other hand, although not shown in detail, at the maximum heating position, the tip portion of the air mixing damper main body 42 comes into contact with the third end portion t3 of the guide partition wall portion 10 from the air mixing space 91 side. At the same time, the reheating prevention damper 43 comes into contact with an upper end of the heater core 2 from the return space 83 side. Accordingly, the cooling space 7 and the heating space 8 communicate with each other, and the heating space 8 and the air mixing space 91 communicate with each other via the return space 83.

In the air mixing space 91, an inner wall of the unit case 3 forms the foot discharge flow path 92 at a region that faces the guide partition wall portion 10 in the traveling direction (that is, above the heating space 8). The foot discharge flow path 92 communicates with a foot discharge outlet (not shown) for sending air to the feet of an occupant in the vehicle.

An end portion (an end portion on the air mixing space 91 side) of the foot discharge flow path 92 is a foot introduction inlet E1 for introducing air from the air mixing space 91. The foot introduction inlet E1 is an opening that extends in the vertical direction as seen in the cross-sectional view. An upper end of the foot introduction inlet E1 is a fifth end portion t5, and a lower end thereof is a sixth end portion t6.

The foot switching damper 5 is provided in the foot discharge flow path 92. The foot switching damper 5 is a plate-shaped member that is rotatably supported in the foot discharge flow path 92. More specifically, the foot switching damper 5 includes a rotary shaft 51 (second rotary shaft) that rotates around a central axis A2 (second central axis) extending in the vehicle width direction and a foot switching damper main body 52 (foot damper main body) that extends on a plane intersecting the width direction with the rotary shaft 51 interposed therebetween. The area of the foot switching damper main body 52 is the same as the cross-sectional area of the foot discharge flow path 92.

An accommodation space 5V for accommodating the foot switching damper 5, which is recessed upward, is formed on an inner surface of the foot discharge flow path 92. That is, when the foot switching damper 5 is at an opening position, the foot switching damper 5 is accommodated in the accommodation space 5V. As seen in a direction in which the foot discharge flow path 92 extends, the foot switching damper 5 accommodated in the accommodation space 5V does not protrude to the inside of the foot discharge flow path 92. In other words, in this state, a surface of the foot switching damper 5 is flush with the other inner surface of the foot discharge flow path 92.

Yet another space is formed above the air mixing space 91. This space is the relay space 93. The relay space 93 is a space for distributing air supplied from the air mixing space 91 to the defroster discharge flow path 95, the center discharge flow path 94A, and the side discharge flow path 94B, which will be described later.

At a region that faces the foot introduction inlet E1 in the traveling direction, the defroster discharge flow path 95 is formed by an inner wall of the unit case 3. The defroster discharge flow path 95 extends in the vertical direction and communicates with a defroster discharge outlet (not shown) through which air for defrosting is sent from the inside of the vehicle to a windshield (front window).

An end portion (an end portion on the relay space 93 side) of the defroster discharge flow path 95 is a defroster introduction inlet E2 for introducing air from the relay space 93. The defroster introduction inlet E2 is an opening that extends in the vertical direction as seen in the cross-sectional view. An upper end portion of the defroster introduction inlet E2 is a seventh end portion t7, and a lower end portion thereof is an eighth end portion t8.

The defroster discharge flow path 95 is provided with the defroster switching damper 6. The defroster switching damper 6 is a plate-shaped member that is rotatably supported above the defroster introduction inlet E2. More specifically, the defroster switching damper 6 includes a rotary shaft 61 that rotates around a central axis A3 extending in the vehicle width direction and a defroster switching damper main body 62 that extends from the rotary shaft 61 on a plane intersecting the width direction.

Yet other spaces are formed above the relay space 93. These spaces are the center discharge flow path 94A and the side discharge flow path 94B. The center discharge flow path 94A is a flow path into which air supplied from the relay space 93 is taken and through which the air is sent to a center discharge outlet (not shown) provided at the center portion of an instrument panel of the vehicle. The side discharge flow path 94B is a flow path through which air is sent to side discharge outlets (not shown) provided at both end portions of the instrument panel of the vehicle. The center discharge outlet and the side discharge outlets are provided mainly for the purpose of sending cold air or warm air toward the upper part of the body of an occupant.

The center discharge flow path 94A and the side discharge flow path 94B are arranged to be adjacent to each other in the traveling direction of the vehicle. The center discharge flow path 94A and the side discharge flow path 94B extend in different directions. Specifically, the center discharge flow path 94A extends to an upper side from a lower side in the vertical direction while being closer to the upper side toward a rear side from a front side in the traveling direction of the vehicle. The side discharge flow path 94B extends in the vertical direction. The center discharge flow path 94A is provided behind the side discharge flow path 94B in the traveling direction of the vehicle.

The center discharge flow path 94A is formed by a center discharge flow path forming portion 3A, which has a tubular shape and is a portion of the unit case 3. An end portion of the center discharge flow path forming portion 3A that is on the relay space 93 side is a center opening E3 that is open toward the relay space 93. The side discharge flow path 94B is formed by a side discharge flow path forming portion 3B, which has a tubular shape and is a portion of the unit case 3. An end portion of the side discharge flow path forming portion 3B that is on the relay space 93 side is a side opening E4 that is open toward the relay space 93.

The face damper 9 is attached between the center discharge flow path 94A and the side discharge flow path 94B. More specifically, the face damper 9 is provided at a ninth end portion t9 at which an inner surface of the center discharge flow path 94A and an inner surface of the side discharge flow path 94B intersect each other. The face damper 9 causes the center discharge flow path 94A and the side discharge flow path 94B to switch between an open state and a closed state.

The face damper 9 includes a rotary shaft 31 that is rotatable around a central axis A4 extending in the vehicle width direction and includes a first damper main body 32 and a second damper main body 33 that are provided at the rotary shaft 31 and that extend in different directions from each other toward a radial outer side with respect to the central axis A4. The rotary shaft 31 is rotatably supported at the ninth end portion t9 described above. The first damper main body 32 has a plate-like shape extending toward the center discharge flow path 94A side from the rotary shaft 31. The second damper main body 33 has a plate-like shape extending toward the side discharge flow path 94B side from the rotary shaft 31.

A dimension from the rotary shaft 31 to a tip portion of the first damper main body 32 is equal to a dimension from the ninth end portion t9 to the fifth end portion t5. A dimension from the rotary shaft 31 to a tip portion of the second damper main body 33 is equal to a dimension from the ninth end portion t9 to the seventh end portion t7. Furthermore, when the face damper 9 is at a closing position, the first damper main body 32 extends on a plane orthogonal to a direction in which the center discharge flow path 94A extends. Furthermore, when the face damper 9 is at the closing position, the second damper main body 33 extends on a plane that is different from the plane on which the first damper main body 32 extends and that is orthogonal to a direction in which the side discharge flow path 94B extends. That is, the center opening E3 of the center discharge flow path 94A and the side opening E4 of the side discharge flow path 94B are provided to be closed by the first damper main body 32 and the second damper main body 33 of the face damper 9 when the face damper 9 is at the closing position. Note that the expression “a direction in which a flow path extends” herein means the normal direction of an opening plane of each flow path. Furthermore, “being orthogonal” may not mean being strictly orthogonal, and slight manufacturing errors, tolerances, and the like are allowed as long as the configuration is made to achieve an orthogonal state.

According to the above-described configuration, the mixing ratio between cold air from the cooling space 7 and warm air from the heating space 8 is adjusted, and the state of distribution of air to each flow path (foot discharge flow path 92, defroster discharge flow path 95, center discharge flow path 94A, and side discharge flow path 94B) is switched with the air mixing damper 4, the foot switching damper 5, the defroster switching damper 6, and the face damper 9 rotated.

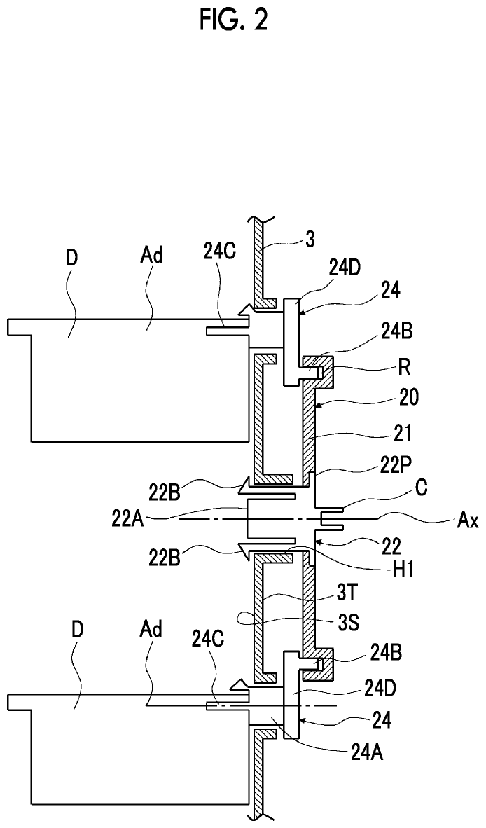

Here, the air mixing damper 4, the foot switching damper 5, the defroster switching damper 6, and the face damper 9 described above are supported at the unit case 3 by means of a configuration as shown in FIG. 2. Note that in an example shown in FIG. 2, the air mixing damper 4, the foot switching damper 5, the defroster switching damper 6, and the face damper 9 are collectively shown as the dampers D. In other words, a configuration described below can be applied to any combination including any two or more of the air mixing damper 4, the foot switching damper 5, the defroster switching damper 6, and the face damper 9. In addition, although only two dampers D are shown in FIG. 2, it is also possible to apply the configuration described below to three or more dampers D.

As shown in FIG. 2, each damper D is rotatably supported with respect to the unit case 3 by the damper lever 24. More specifically, the damper lever 24 includes a damper lever main body 24A, a pin 24B, a damper supporting portion 24C, and a plate-shaped portion 24D. The damper lever main body 24A is rotatable around a damper axis Ad that extends in a direction orthogonal to a wall surface (unit case inner surface 3S or unit case outer surface 3T) of the unit case 3.

An end portion of the damper lever main body 24A that is on the unit case inner surface 3S side is integrally provided with the damper supporting portion 24C for supporting and fixing the damper D. An end portion of the damper lever main body 24A that is on the unit case outer surface 3T side is integrally provided with the plate-shaped portion 24D that extends within a plane orthogonal to the damper axis Ad. The pin 24B is provided at a position on the plate-shaped portion 24D that is eccentric with respect to the damper axis Ad. The pin 24B has a rod-like shape that protrudes from the plate-shaped portion 24D in a direction parallel to a rotation axis (damper axis Ad) of the damper D. That is, it is possible to rotate the damper lever 24 and the damper D around the damper axis Ad by applying a force to the pin 24B. Note that being “parallel” means being substantially parallel, and manufacturing tolerances and errors are allowed.

The damper levers 24 are rotated by the main lever 20 via the pins 24B. The main lever 20 is supported by the unit case 3 at a through-hole (support hole H1) formed in the unit case 3. Specifically, the main lever 20 includes a main lever main body 21 that has a plate-like shape and that covers each of the damper levers 24 from the unit case outer surface 3T side and a shaft portion 22 that supports the main lever main body 21 such that the main lever main body 21 can rotate around an axis Ax.

Guiding grooves R, into which the pins 24B of the damper levers 24 described above are fitted, are formed at outer peripheral edges on a surface of the main lever main body 21 that faces the unit case outer surface 3T side. Although not shown in detail, each guiding groove R extends along the rotation trajectory of the pin 24B around the damper axis Ad. That is, in a case where the main lever 20 is rotated around the axis Ax, the pins 24B are guided along the guiding grooves R, and the postures (angles of rotation) of the dampers D are changed.

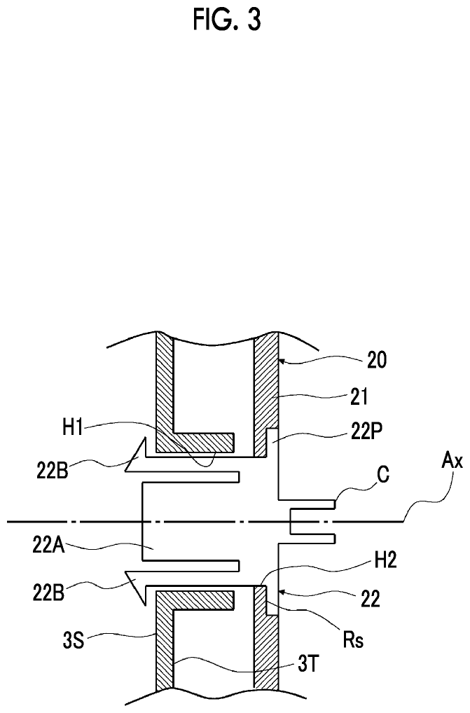

A through-hole H2 (refer to FIG. 3) that penetrates the main lever main body 21 in a direction along the axis Ax is formed at the center portion of the main lever main body 21. The shaft portion 22 is fixed at the through-hole H2. The shaft portion 22 includes a shaft portion main body 22A that has a columnar shape centered on the axis Ax, a plurality of claw portions 22B provided on an outer peripheral side of the shaft portion main body 22A, and an extension portion 22P that is provided on a side opposite to the claw portions 22B of the shaft portion main body 22A. The plurality of claw portions 22B have an outer diameter dimension slightly larger than the support hole H1 formed in the unit case 3. After the claw portions 22B are press-fitted into the support hole H1 by means of elastic deformation, the claw portions 22B are exposed on the unit case inner surface 3S side, so that the shaft portion 22 is engaged with the support hole H1 so as not to fall off from the support hole H1.

Furthermore, an end portion of the shaft portion 22 that is on a side opposite to the claw portions 22B is integrally formed with the extension portion 22P that extends in a radial direction with respect to the axis Ax. The extension portion 22P is accommodated in an accommodation recess Rs formed to be coaxial with the through-hole H2 of the main lever main body 21. Furthermore, the end portion of the shaft portion 22 that is on a side opposite to the claw portions 22B is integrally provided with a connecting portion C that has a tubular shape centered on the axis Ax. A driving source (actuator) (not shown) is connected to the connecting portion C. That is, the main lever 20 is rotated around the axis Ax by means of a rotational force applied from the driving source.

In the above-described configuration, the main lever 20 is rotated in a state of being inserted into the support hole H1 formed in the unit case 3. In addition, the guiding grooves R formed in the main lever 20 are in a state of being in sliding contact with the pins 24B of the damper levers 24. Therefore, it is necessary to reduce friction generated between the main lever 20, the damper levers 24, and the unit case 3. Here, in the related art, each of the main lever 20 and the damper levers 24 is generally integrally formed of polyacetal (POM) or polybutylene terephthalate (PBT).

However, since the main lever 20 and the damper levers 24 slide on each other as described above, in a case where the main lever 20 and the damper levers 24 are formed of the same member, a frictional force generated between the main lever 20 and the damper levers 24 becomes large. As a result, sliding portions between the main lever 20 and the damper levers 24 may be worn or deteriorated at an early stage. As a result, the durability of the air conditioner for a vehicle is limited.

Therefore, in the present embodiment, the main lever 20 is divided into two members (that is, main lever main body 21 and shaft portion 22), and these members are formed of different materials. More specifically, the shaft portion 22 has a toughness higher than the main lever main body 21 and is formed of a material different from the unit case 3. As a specific example of such a material, the shaft portion 22 and the damper levers 24 are formed of one material selected from a group including polyacetal (POM) and polybutylene terephthalate (PBT), and the main lever main body 21 and the unit case 3 are formed of polypropylene (PP). Therefore, slide-contact portions between the shaft portion 22 and the unit case 3, slide-contact portions between the damper levers 24 and the unit case 3, and slide-contact portions between the damper levers 24 and the main lever 20 can be formed of different materials from each other. As a result, in comparison with a case where the slide-contact portions are formed of the same material, wear and deterioration of the slide-contact portions can be reduced, for example.

As described above, according to the above-described configuration, the main lever 20 includes the main lever main body 21 and the shaft portion 22. Of these, the shaft portion 22 has a toughness higher than the main lever main body 21 and is formed of a material different from the unit case 3. Therefore, in comparison with a configuration in which the shaft portion 22 and the unit case 3 are formed of the same material, a frictional force generated between the shaft portion 22 and the unit case 3 can be reduced. Furthermore, since the main lever main body 21 and the shaft portion 22 are formed of different materials from each other, the damper levers 24 sliding on the main lever main body 21 can be formed of the same material (for example, POM) as the shaft portion 22. In this case as well, a frictional force generated between the damper levers 24 and the main lever main body 21 can be reduced. Furthermore, since the types of materials required can be reduced, cost reduction can be realized.

Furthermore, according to the above-described configuration, the shaft portion 22 is engaged with the unit case 3 from one side in a direction along the axis Ax direction via the claw portions 22B and is fixed to the unit case 3 from the other side by means of the extension portion 22P provided on the end portion that is on the side opposite to the claw portions 22B. That is, since the extension portion 22P is provided, it is possible to eliminate a possibility that the shaft portion 22 falls off toward the other side from the one side.

In addition, in the present embodiment, the above-described configuration can be applied to the air mixing damper 4 as the damper D. Here, the air mixing damper 4 generally rotates more frequently than the other dampers at the time of adjustment of the temperature of air to be sent. That is, it is particularly important to reduce a frictional force caused by a sliding motion between the air mixing damper 4 and the unit case 3. According to the above-described configuration, a frictional force generated between the air mixing damper 4 and the unit case 3 can be reduced, and it is possible to more stably operate the air conditioner 100 for a vehicle.

The embodiment of the present invention has been described above. Note that the above-described configuration can be changed and modified in various ways without departing from the gist of the present invention.

### REFERENCE SIGNS LIST

1: evaporator

2: heater core

3: unit case

3A: center discharge flow path forming portion

3B: side discharge flow path forming portion

3S: unit case inner surface

3T: unit case outer surface

4: air mixing damper

5: foot switching damper

6: defroster switching damper

7: cooling space

8: heating space

9: face damper

10: guide partition wall portion

20: main lever

21: main lever main body

22: shaft portion

22A: shaft portion main body

22B: claw portion

22P: extension portion

24: damper lever

24A: damper lever main body

24B: pin

24C: damper supporting portion

24D: plate-shaped portion

31: rotary shaft

32: first damper main body

33: second damper main body

41: rotary shaft

42: air mixing damper main body

43: reheating prevention damper

51: rotary shaft

52: foot switching damper main body

61: rotary shaft

62: defroster switching damper main body

71: introduction space

72: cold air supply space

81: second introduction space

82: warm air supply space

83: return space

91: air mixing space

92: foot discharge flow path

93: relay space

94A: center discharge flow path

94B: side discharge flow path

95: defroster discharge flow path

100: air conditioner for vehicle

Ad: damper axis

Ax: axis

C: connecting portion

D: damper

H1: support hole

H2: through-hole

R: guiding groove

Rs: accommodation recess

t1: first end portion

t2: second end portion

t3: third end portion

t5: fifth end portion

t6: sixth end portion

t7: seventh end portion

t8: eighth end portion

t9: ninth end portion

1. An air conditioner for a vehicle which is installed in the vehicle, the air conditioner comprising:
an evaporator that cools air;
a heater core that heats the air;
a unit case that accommodates the evaporator and the heater core and in which an air mixing space where the air supplied from the evaporator and the air supplied from the heater core are mixed with each other is defined and a plurality of flow paths through which the air mixed in the air mixing space flows are formed;
a plurality of dampers that cause the plurality of flow paths to switch between an open state and a closed state;
a plurality of damper levers that rotatably support the plurality of dampers with respect to the unit case and that include pins extending to be parallel to rotation axes of the dampers; and
a main lever in which a guiding groove into which the pins are fitted is formed and that rotates around an axis to guide the pins and to rotate the damper levers,
wherein the main lever includes
a main lever main body in which the guiding groove is formed, and
a shaft portion that is provided at a position of the axis, supports the main lever main body with respect to the unit case such that the main lever main body is rotatable around the axis, and is provided with a claw portion that is engaged with the unit case so as not to fall off from the unit case, and
the shaft portion has a toughness higher than the main lever main body and is formed of a material different from the unit case.

2. The air conditioner for a vehicle according to claim 1,
wherein the shaft portion and the damper levers are formed of one material selected from the group consisting of polyacetal and polybutylene terephthalate, and
the main lever main body is formed of polypropylene.

3. The air conditioner for a vehicle according to claim 1,
wherein an extension portion that extends in a radial direction with respect to the axis is formed at an end portion of the shaft portion that is on a side opposite to the claw portion.

4. The air conditioner for a vehicle according to claim 1,
wherein at least one of the plurality of dampers is an air mixing damper that is provided in the air mixing space and that adjusts a mixing state of the air supplied from the evaporator and the air supplied from the heater core.
